(19) United States
(12) Patent Application Publication
(10) Pub. No.: US 2003/0025732 A1
(43) Pub. Date: Feb. 6, 2003

(54) Method and apparatus for providing customizable graphical user interface and screen layout

(76) Inventor: Scot D. Prichard, Muskego, WI (US)

Correspondence Address: OSTRAGER CHONG & FLAHERTY LLP, 825 THIRD AVE, 30TH FLOOR, NEW YORK, NY, 10022-7519, US

(21) Appl. No.: 09/918,786

(22) Filed: Jul. 31, 2001

(51) Int. Cl. G09G 5/00

(52) U.S. Cl. 345/765

(57) ABSTRACT

A system and a method for providing customized graphical user interfaces and/or screen layouts in computer systems. A web browser is nested in an application. XML text files are used to describe one or more user interfaces. The application software uses the information (e.g., source code) in the XML files to generate the user interface. For dynamic updates this may be done “on the fly,” allowing changes to the files and the addition/deletion of files even at run-time. The general layout of a user interface is defined in an HTML-based template. The details of the user interface are generated by software which retrieves a selected XML display/editor template text file, populates the XML display/editor text with current system data, converts the XML data to HTML, and then populates the HTML template to produce an HTML-based text for display. The user interface is then generated from the HTML-based display text by the web browser.

### BACKGROUND OF THE INVENTION

This invention relates to graphical user interfaces for use in computer systems.

A graphical user interface developed in a standard programming language such as C, C++, Visual Basic, or Java is a single-point solution to a single set of editing requirements. The implementation defines the data format, location on the screen, presentation format, and the associated application data for each display field. There are a number of problems with this approach.

First, the resulting single-point implementation cannot operate seamlessly from any computer on the intranet or internet. Each computer must have the software installed, or a third-party tool to transfer the view of the application running on a host machine to a remote computer.

Second, when using a common set of software for multiple applications with distinct requirements, such as distinct products, locations, user categories, users and user skill levels, the user interface must be manually customized or rewritten for each application need. The added time, effort, and cost of this customization is significant.

Third, translation into multiple languages requires redesign of the screen layout to accommodate varying text widths.

Thus there is a need for a technique whereby graphical user interfaces and screen layouts can be easily customized with significant reductions in time, effort and cost.

Although it is believed that a person skilled in the art of web technologies would understand the terms and acronyms used herein, the following explanation of certain terms is provided for the sake of certitude in claim construction.

HTML (HyperText Markup Language) is the language used to create documents on the World Wide Web. HTML defines the structure and layout of a web document by using a variety of tags (words bracketed by ‘<’ and ‘>’) and attributes (of the form name=“value”). Tags are also used to specify hypertext links.

XML (short for Extensible Markup Language) is a method for putting structured data in a text file. Like HTML, XML uses tags and attributes. XML allows designers to create their own customized tags.

The Document Object Model (DOM), developed by the World Wide Web Consortium, is an application programming interface (API) for HTML and XML documents, and comprises a standard set of function calls for manipulating XML (and HTML) files from a programming language. The DOM defines standard interfaces to a document of tree-structured data objects.

Dynamic HTML (DHTML) refers to new HTML extensions that will enable a web page to react to user input without sending requests to a web server. DHTML relies on the DOM to dynamically change the appearance of web pages after they have been downloaded to a user's browser.

XSL (short for Extensible Style Language) is a template-like specification for separating style from content when creating HTML or XML pages.

STL (Standard Template Library) is part of the C++ language.

ATL (Active Template Library) is Microsoft's extension to STL.

COM (Component Object Model) is Microsoft's standard communication protocol to be used between different applications

### SUMMARY OF THE INVENTION

The present invention is directed to a system and a method for providing customized graphical user interfaces and/or screen layouts in a computer system. In accordance with the preferred embodiment, a web browser is nested in an application and used to convert internally generated HTML text files into displayed graphical user interfaces. Aspects of the application user interface are defined in one or more XML text files which are primarily data files, although they contain what may be considered source code. To define a user interface, the XML text file(s) contain a sufficient definition of the data format, relative location on the screen, presentation format, and application data identifier(s) for each display field. For example, each file could define a dialog box or a tab in a dialog box.

In accordance with the preferred embodiment, the user selects a user interface, which the application software uses to select a user interface definition file. The application loads the selected user interface definition file (a text file in XML format) and populates it with the current application data. Then the application opens a dialog and in the dialog opens a web browser. The dialog selects the general layout by selecting an HTML general layout text file from the user interface definition files. The retrieved XML and HTML text files are templates which need to be filled in. The in-memory representation of these files is accomplished using software that supports the DOM interface. One portion of the user interface generation software populates the XML file with the current application data using a DOM. Another portion of the user interface generation software, i.e., scripting software, converts the populated XML DOM to HTML and then uses the resulting HTML text to fill in the selected HTML template. The end result is an HTML-based graphical user interface in the web browser.

In accordance with the preferred embodiment of the invention, the user can edit the current application data by interacting with the graphical user interface, invoking DHTML events that are handled by scripting software. This provides a dynamic editing environment in which the user can edit freely.

The advantages of the invention are manifold. The addition of new general user interface layout files to the system adds new general user interface layouts to the application. The addition of display/edit definition files to the system adds new displays/editors to the application. Customization is achieved simply by editing user interface definition files (display/edit or general layout). The use of HTML leverages a browser's capability to dynamically layout the display based on the general layout, the fields to display, and even the language translated text. The use of web technologies enables the display of the user interface locally and on a remote computer. Lastly, the use of web technologies such as DHTML, XML, XSL, and scripting leverages a browser's capability to provide an interactive user interface.

Other aspects of the invention are disclosed and claimed below.

### BRIEF DESCRIPTION OF THE DRAWINGS

FIG. 1 is a combination block diagram/flowchart showing the concept of the present invention.

FIG. 2 is a block diagram outlining and showing nesting of technologies in accordance with the preferred embodiment of the invention.

FIG. 3 is a flowchart showing the data flow for the Initial Update function in accordance with the preferred embodiment of the invention.

FIG. 4 is a flowchart showing the data flow for the Navigation function in accordance with the preferred embodiment of the invention.

FIG. 5 is a flowchart showing the data flow for the Editing function in accordance with the preferred embodiment of the invention.

FIG. 6 is a flowchart showing the data flow for the Save function in accordance with the preferred embodiment of the invention.

FIG. 7 is a schematic depicting a document of tree-structured data objects defined by the W3C Document Object Model.

FIG. 8 is a schematic depicting a screen shot of the HTML editor in accordance with the preferred embodiment of the present invention.

### DETAILED DESCRIPTION OF THE PREFERRED EMBODIMENTS

Although the concept of the invention and the preferred embodiment of the invention will be disclosed in the context of a scanner, the invention has application in computer systems other than scanners. A computer system typically comprises a computer, software, system memory, a storage device (e.g., a hard disk), an operator interface (e.g., a keyboard and a mouse), and a display monitor. Such components are well known and require no further description. The invention is preferably implemented in software in a computer system.

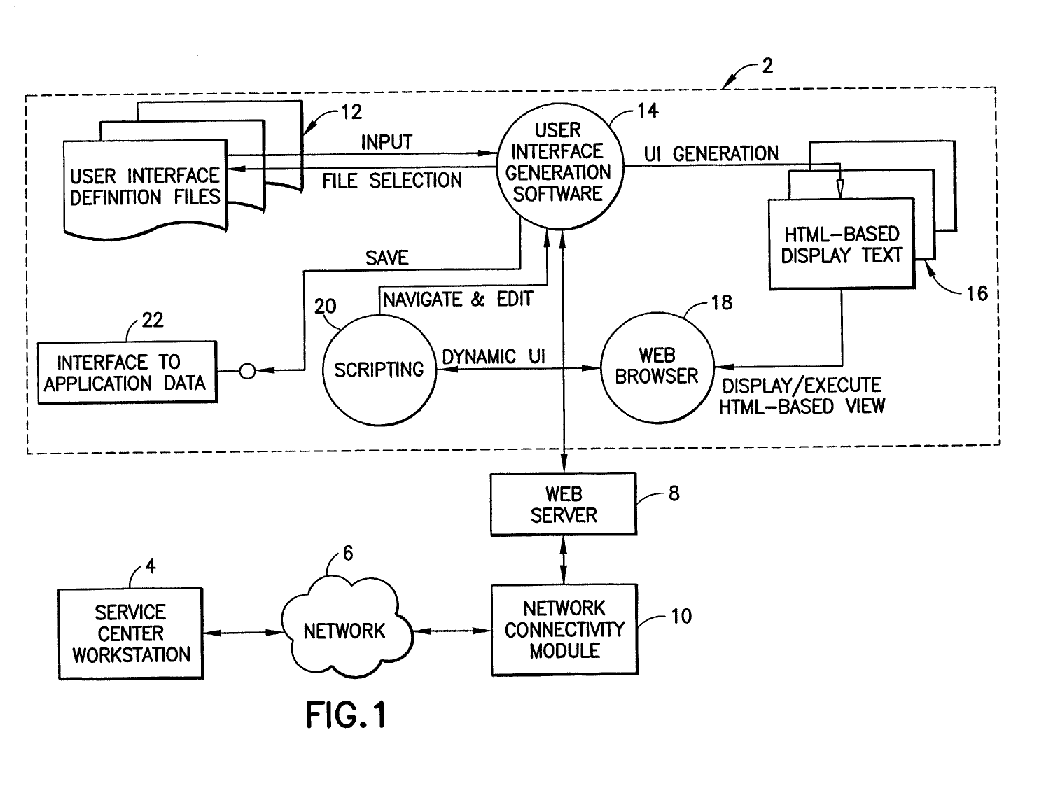

The concept of the invention is generally represented by the flowchart inside dashed outline 2 in FIG. 1. For the disclosed preferred embodiment, the numeral 2 designates a scanner. The scanner may belong to any one of a multiplicity of modalities, e.g., ultrasound, X-ray, MRI, etc. Each modality of diagnostic imaging system has been described extensively in the prior art and no further description will be provided here. For example, it is well known that a typical ultrasound imaging system comprises a transducer probe, a beamformer, a signal processing module, and a display processing module. The structure and function of each of these components is well known.

In accordance with the preferred embodiment, the scanner 2 is able to communicate with a central computer, e.g., a service center workstation 4, via a network 6 (e.g., an LAN, an intranet, the Internet, etc.). The scanner 2 connects to the network 6 via a web server 8 and a network connectivity module 10. The server 8 facilitates data exchange between the scanner 2 and the service center, and permits a series of web pages to be viewed via the scanners web browser 18. The web server 8 also enables the transmission of scanner data from the scanner 2 to the service center workstation 4 for the purpose of set up and diagnosis of the setup, as will be described in more detail later.

The concept of the invention is generally shown in the flowchart portion of FIG. 1. User interface definition files 12 are resident on the hard disk of the scanner. The system computer is programmed with application software (not shown), user interface generation software 14, a web browser 18, and scripting software 20. The user interface definition files 12 comprise general screen layout text files written in HTML format and display/editor text files written in XML format. Each XML display text contains text representing display fields for the graphical user interface. In response to selection of a user interface by the system user, the user interface generation software retrieves the appropriate XML display/editor text file, arranges the text file in a DOM format. i.e., a tree of data objects, and then populates the display fields with the current application data corresponding to those fields by navigating the XML nodes in the DOM. The user interface generation software also retrieves the appropriate HTML general layout text file. Based on the retrieved HTML general layout file (i.e., template) and a populated XML display/editor text file (derived from the populated DOM), the user interface generation software 14 generates HTML-based display text 16. The web browser 18 displays a user interface screen based on the information in the HTML-based display text 16. The user interface screen has an Editor window. DHTML and web scripting software 20 enable the user to dynamically change or edit files by interacting with the displayed graphical user interface.

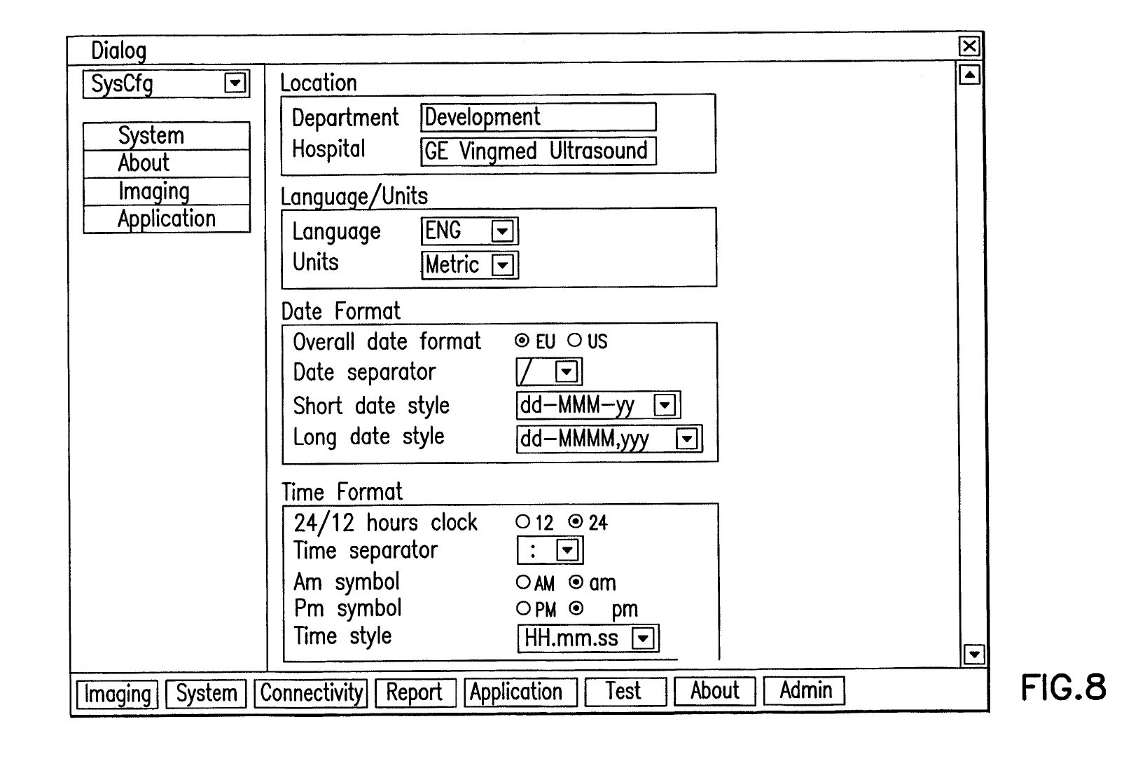

A screen shot of a representative dialog, having a left pane for navigation and a right pane for editing, is shown in FIG. 8. When the user makes a selection in the left pane of the dialog, DHTML invokes a script which recreates the right pane based on the selection (indicated by the arrow labeled Navigate in FIG. 1). When the user changes a value in a display field in the right pane using DHTML (thereby making it unnecessary to load a new HTML-based display text file in the web browser), the DHTML software for the right pane invokes a script which changes the value stored by the user interface generation software 14. This editing operation is indicated by the arrow labeled Edit in FIG. 1. Later, when the user enters a Save command, the application software queries the user interface generation software 14 and writes the changes back to the application (system) data via the interface 22. This store operation is indicated by the arrow labeled Save in FIG. 1.

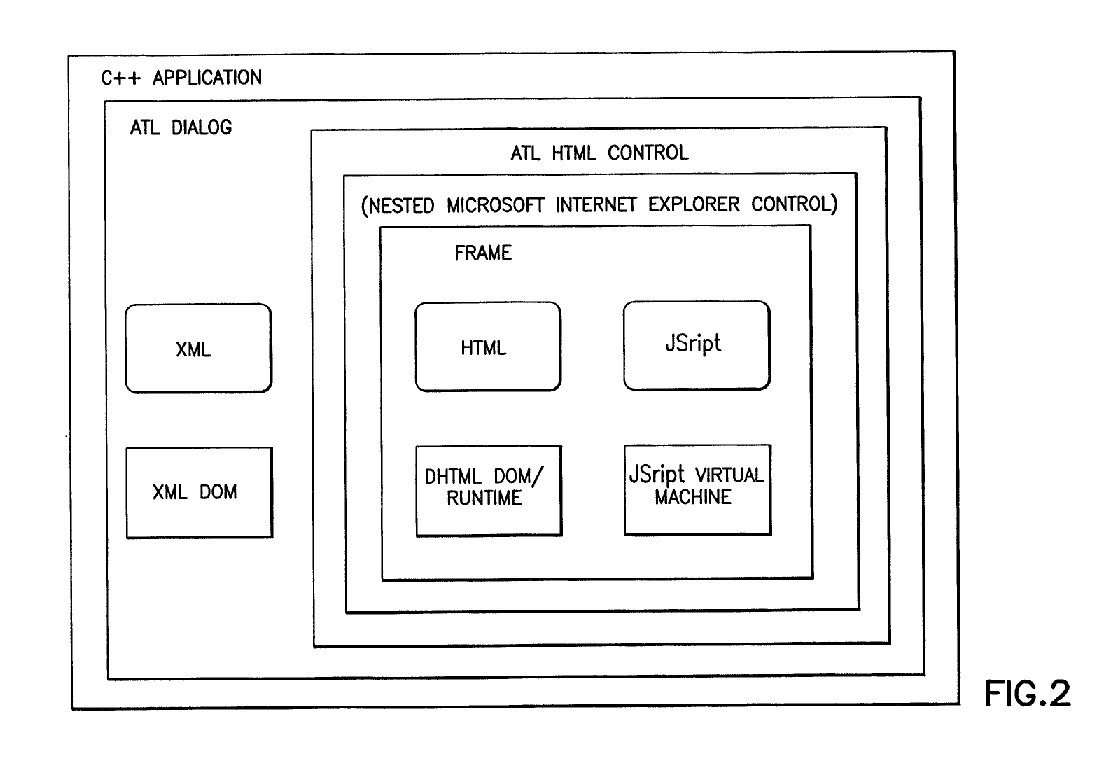

The preferred embodiment of the invention employs nested technologies. The technology nesting is illustrated in FIG. 2. In accordance with the preferred embodiment of the invention, the application is authored in C++. The preferred web browser is Microsoft Internet Explorer, which is nested in the C++ application. XML text files are used to describe one or more user interfaces to be displayed by the web browser. An ATL dialog provides the necessary support for COM interfaces to the ATL HTML Control. The ATL HTML Control is a wrapper for Microsoft Internet Explorer. The web browser comprises JScript, while the scripting software (20 in FIG. 1) corresponds to the JScript software indicated in FIG. 2. Editing is fast with client side scripting.

The W3C Document Object Model (DOM) defines standard interfaces to a document of tree structured data objects. Microsoft Internet Explorer uses the Microsoft implementation of the W3C DOM for the in-memory representation of DHTML and XSL. Since the ATL HTML Control is simply a wrapper for Microsoft Internet Explorer, the preferred embodiment of the invention uses the Microsoft DOM Control. Microsoft's DOM Control is tightly integrated with Visual C++ and JScript through its COM interface. Since the Microsoft DOM is already in use by the ATL HTML Control, it was chosen to represent the XML data as well. The Microsoft XML DOM requires fully compliant XML text, such as including a closing tag for each opening tag. The XML DOM is constructed and populated in the C++ source code for excellent performance.

The ATL dialog is responsible for creating the XML DOM based on a resource template, namely, the selected XML display/edit text file. This XML template uses attributes to define the presentation format. First, the template text is read in from the file and passed to the DOM. The XML DOM parses the text and converts it to an in-memory object representation, i.e., a document of tree-structured data objects of the type shown in FIG. 7. By navigating the DOM nodes, the current value of each node is re-read from the system and updated in the DOM. Thus the filled-in template defines the data to be transferred to the view.

The ATL HTML Control is directed to load the HTML resource template, i.e., general layout text file. For this application the HTML templates includes a menu bar and a scrolling frame to display a left navigation pane and a right editing pane, as shown in FIG. 8. Selecting a heading in the left pane displays the corresponding values for the selected node and all its children in the right pane.

The user interface generation software, referred to in connection with FIG. 1, corresponds to a complex of code and data all working together. In accordance with the preferred embodiment shown in FIG. 2, the C++ application software populates an XML display/editor text file with the current application data. The JScript software converts the data in the XML DOM to HTML and then uses the resulting HTML text to populate the selected HTML template. The end result is an HTML-based display in the web browser.

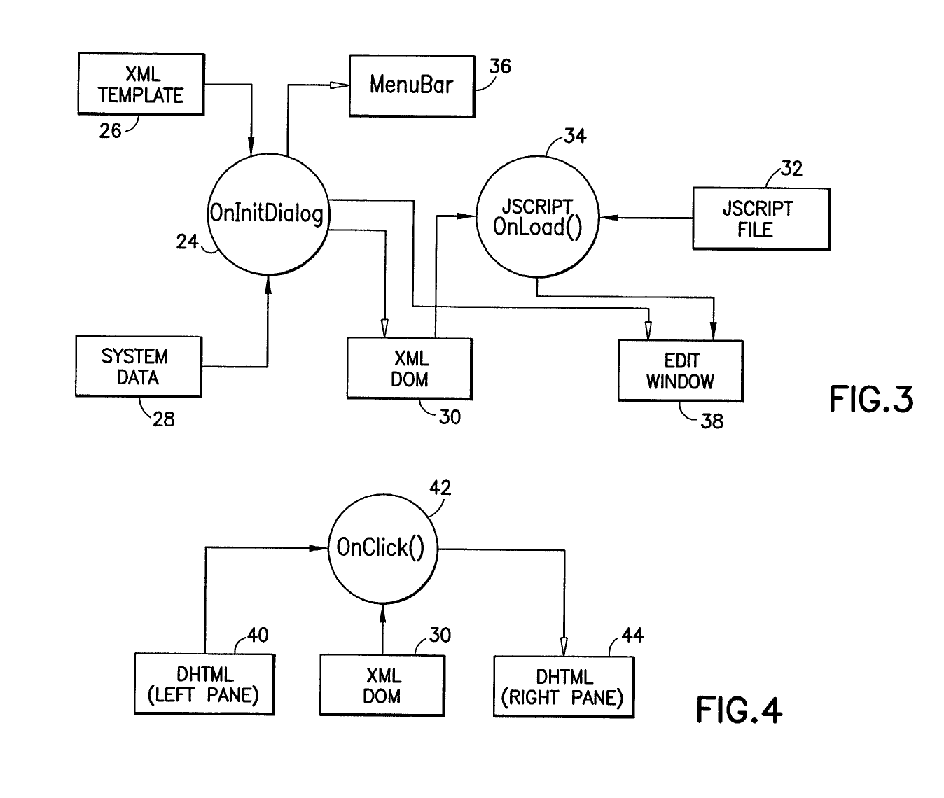

The data flow for various processes in accordance with the preferred embodiment will now be described with reference to FIGS. 3-6.

FIG. 3 shows the data flow for the Initial Update process in accordance with the preferred embodiment of the invention. When the user opens the ATL dialog and selects a user interface, the C++ application software selects the appropriate user interface definition file (i.e., text file in XML format). A smart pointer to the XML DOM Control is declared in the ATL Dialog. The control is created, populated and passed to the ATL HTML Control during OnInitDialog( ). The OnInitDialog function 24 of the ATL dialog reads the XML template file 26 and the current system data 28, and then constructs and populates an XML DOM 30 based on the XML template and the current system data. The JScript OnLoad( ) function 34 uses the data in the XML DOM to create HTML text. OnLoad( ) then uses DHTML to populate the HTML template in the web browser window 38 with the created HTML text.

The HTML file is displayed in the edit window 38, which defines frames for a MenuBar 36 and a scrollable region for the general layout HTML template 32. The general layout HTML 32 is displayed in the top frame having left and right panes to be populated by JScript. The right pane is an Edit window 38 and the left pane is a Navigation window.

FIG. 4 shows the data flow involved in the Navigation process in accordance with the preferred embodiment of the invention. When the user selects a node in the left pane of the dialog window, DHTML 40 invokes the OnClick( ) JScript function 42. OnClick then uses the selection to look up the corresponding node in the XML DOM 30. The JScript recreates the right pane 44 based on the selected XML DOM node.

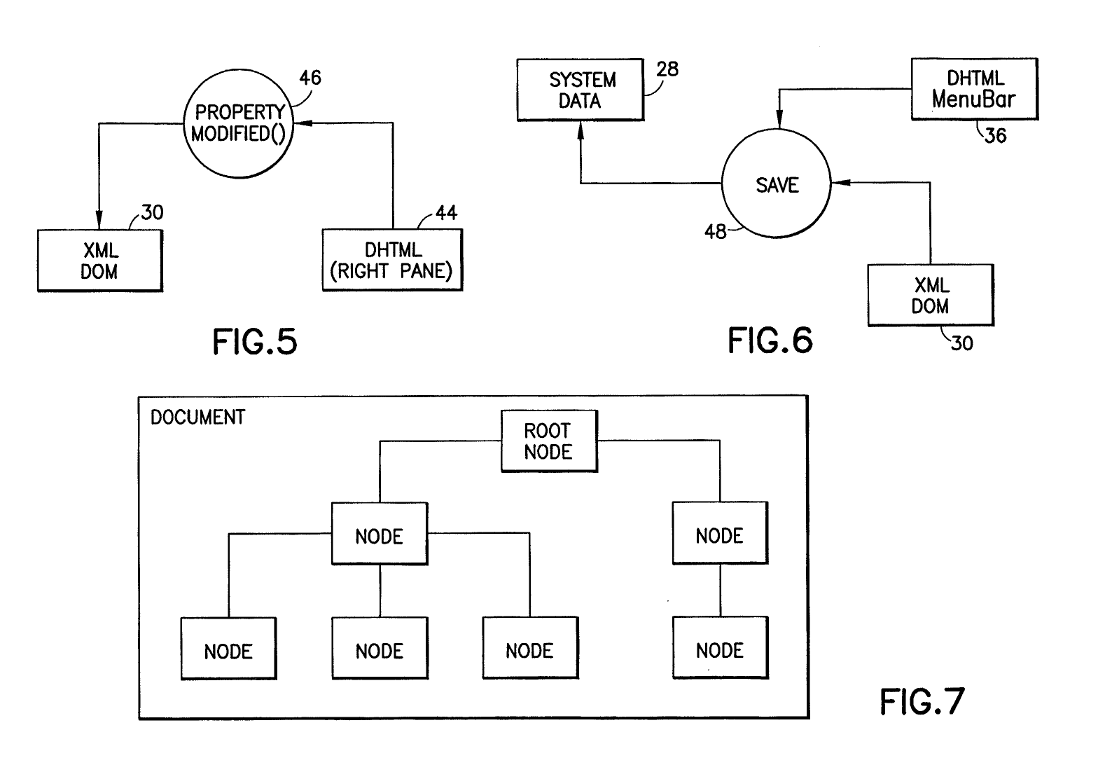

FIG. 5 shows the data flow for the Editing process in accordance with the preferred embodiment of the invention. Each time the property of an edit control changes, such as the user editing the value, DHTML 44 for the right pane invokes the OnChangedProperty JScript function. The script uses parameters passed to determine the new value, and which node of the XML DOM 30 to update. That node is then updated. A “modified” attribute 46 is added to the node to be updated so the Save process can save only the changes.

FIG. 6 shows the data flow for the Save process in accordance with the preferred embodiment of the invention. The Save process 48 (selected via the menu bar 36) notifies the C++ application that the data has changed. The C++ code queries the XML nodes of the DOM 30 for those that have been modified and writes their changes back to the system data 28. More specifically, the DHTML keyword of “onpropertychange” is included with each edit control. Each time a property of a control changes, such as the value due to changes made by the user, the propertychanged function is invoked passing the event (the type of the change), the edit control, and the name of the associated XML node. propertyChanged( . . . ) reads the new value from the edit control and updates the value in the XML DOM. Selecting “Save” notifies the ATL HTML Control, which notifies the ATL dialog to save the updated data from the XML DOM.

The combination of the XML text and the HTML text with additional web technologies, such as web scripting and DHTML, provides a fully interactive user interface. The use of the view component of Microsoft's Internet Explorer (ATL COM HTML Control) supports a seamless display of the HTML-based user interface in C++ applications.

The foregoing preferred embodiment envisions the client and server sides being both incorporated in a scanner. When the remote editor is authored, the JScript will create a local XML DOM and populate it with XML text read from a web server (block 8 in FIG. 1). Activation of the Save function would simply extract the XML text from the local XML DOM and send it back to the web server. In this manner, the local and remote applications are nearly identical.

The remote capability is used by the service center to set up and diagnose the setup of scanners remotely. A scanner typically has thousands of variables for setting specific capabilities, features, image quality, etc. The system user has the ability to modify these settings, sometimes incorrectly, causing the system to malfunction. Thus, a technician at a central service facility must be able to enter the scanner remotely and diagnose the setup. In accordance with one aspect of the present invention, the service center connects to the scanner as if it were a web page. In particular, referring again to FIG. 1, the service person at workstation 4 will open a web page on the scanner's web server 8 and request that the scanner download the HTML general layout text file, the populated XML display/editor text files and the script used to populate the HTML layout file with the XML text. A graphical user interface is displayed at the service center workstation based on the downloaded populated display/editor text, screen layout text, and script. The service technician can then compare the current scanner data displayed in the graphical user interface with reference scanner settings. If any of the scanner settings are sub-optimal, the service technician can edit the scanner data and then upload the edited display/editor text to the scanner.

Acceptable performance during remote editing requires minimal client to server interaction. A dynamic client is achieved using DHTML, JScript, and XML. The combination of dissimilar technologies increases the complexity of the development. The use of the text-based XML standard along with the W3C DOM standard for structured information allows the data to move seamlessly between C++, XSL, and JScript.

Although the preferred embodiment of the invention disclosed above employs Microsoft's XML DOM, an implementation of Microsoft's ATL Dialog and ATL HTML Control, and Microsoft's Internet Explorer, the person skilled in the art of web technologies will readily appreciate that the present invention can be practiced using non-Microsoft products (Java-based XML DOM/SAX, Netscape web browser, JavaScript, etc.)

While the invention has been described with reference to preferred embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. A system comprising a computer, software, system memory, a storage device, an operator interface, and a display monitor, wherein said storage device stores a display/editor text file in a first format and a screen layout text file in a second format different than said first format; said software comprises application software, web scripting software, and web browser software; and in response to an input to said operator interface, said application software combines current system data with data derived from said display/editor text file to create a populated display/editor text in said first format; said web scripting software creates a display text in said second format based at least in part on said screen layout text file and said populated display/editor text file; and said web browser software displays a user interface on said display monitor based on said display text in said second format.

2. The system as recited in claim 1, wherein said first format is XML and said second format is HTML.

3. The system as recited in claim 2, wherein said application software is object-oriented software and further comprises DOM software for constructing tree-structured data objects based on said display/editor text file and populating said tree-structured data objects with said current system data.

4. The system as recited in claim 3, wherein said application software further comprises software for creating said populated display/editor text based on said populated DOM.

5. The system as recited in claim 4, wherein said web scripting software comprises software for translating said populated display/editor text from XML format to HTML format.

6. The system as recited in claim 5, wherein said web scripting software further comprises software for dynamically changing data being displayed in said user interface and software for modifying said tree-structured data objects in accordance with said changes in data.

7. The system as recited in claim 6, wherein said application software further comprises software for extracting modified data from said tree-structured data objects in response to a Save command inputted via said operator interface.

8. The system as recited in claim 1, wherein said web browser is nested in said application software.

9. The system as recited in claim 1, further comprising web server software comprising software for downloading said populated display/editor text, said screen layout text file, and a portion of said web scripting software which translates said populated display/editor text into said second format and then populates said screen layout with said translated text from said populated display/editor text file.

10. The system as recited in claim 1, further comprising components programmed to scan a human body.

11. The system as recited in claim 1, further comprising components programmed to acquire image data using ultrasound.

12. A system comprising a computer, system memory, a storage device, an operator interface, and a display monitor, wherein said storage device stores a display/editor text file in a first format and a screen layout text file in a second format different than said first format; and said computer is programmed to perform the following steps in response to an input to said operator interface:
reading said display/editor text file and said screen layout text from said storage device;
retrieving current system data;
creating a populated display/editor text in said first format which is populated with said retrieved current system data;
creating a display text in said second format based at least in part on said screen layout text file and said populated display/editor text file; and
displaying a user interface on said display monitor based on said display text in said second format.

13. The system as recited in claim 12, wherein said first format is XML and said second format is HTML.

14. The system as recited in claim 13, wherein said computer is further programmed to perform the following steps: constructing tree-structured data objects based on said display/editor text file and populating said tree-structured data objects with said current system data.

15. The system as recited in claim 14, wherein said computer is further programmed to create said populated display/editor text based on said populated DOM.

16. The system as recited in claim 15, wherein said computer is further programmed to translate said populated display/editor text from XML format to HTML format.

17. The system as recited in claim 16, wherein said computer is further programmed to perform the following steps: dynamically changing data being displayed in said user interface; and modifying said tree-structured data objects in accordance with said changes in data.

18. The system as recited in claim 17, wherein said computer is further programmed to extract modified data from said tree-structured data objects in response to a Save command inputted via said operator interface.

19. The system as recited in claim 12, further comprising a web server programmed to download said populated display/editor text, said screen layout text file, and a portion of said web scripting software which translates said populated display/editor text into said second format and then populates said screen layout text with said translated text from said populated display/editor text.

20. A method for displaying a graphical user interface, comprising the following steps:
storing a display/editor text file in a first format;
storing a screen layout text file in a second format different than said first format;
selecting said display/editor text file and said screen layout text in response to an input inputted via an operator interface;
reading current system data from memory;
creating populated display/editor text in said first format which is populated with said current system data;
creating display text in said second format based at least in part on said screen layout text file and said populated display/editor text; and
displaying a graphical user interface based on said display text in said second format.

21. The method as recited in claim 20, wherein said first format is XML and said second format is HTML.

22. The method as recited in claim 21, further comprising the following steps: constructing tree-structured data objects based on said display/editor text file and populating said tree-structured data objects with said current system data.

23. The method as recited in claim 22, further comprising the following steps: dynamically changing data being displayed in said user interface; and modifying said tree-structured data objects in accordance with said changes in data.

24. A method for remotely diagnosing a malfunction of a remotely located scanner from a central service facility, comprising the following steps:
downloading populated display/editor text in a first format from said scanner to said central service facility, said populated display/editor text being populated with current scanner data;
downloading screen layout text in a second format different than said first format from said scanner to said central service facility;
downloading script for creating display text in said second format based at least in part on said screen layout text file and said populated display/editor text file;
displaying a graphical user interface based on said downloaded populated display/editor text, screen layout text and script; and
observing the current scanner data displayed in said graphical user interface.

25. The method as recited in claim 24, further comprising the steps of editing said scanner data and uploading an edited display/editor text in said first format to said scanner.

26. The method as recited in claim 24, wherein said first format is XML and said second format is HTML.

27. A system comprising a first computer system at a remote location, a second computer system at a central location, and a communications channel for connecting said first and second computer systems, wherein said first computer system comprises a computer, software, system memory, an operator interface, and a display monitor, wherein said storage device stores a display/editor text file in a first format and a screen layout text file in a second format different than said first format; said software comprises application software, web scripting software, web browser software, and web server software, and in response to an input to said operator interface, said application software combines current system data with data derived from said display/editor text file to create populated display/editor text in said first format; said web scripting software creates display text in said second format based at least in part on said screen layout text and said populated display/editor text; and said web browser software displays a user interface on said display monitor based on said display text in said second format, and in response to a request received from said second computer system via said communications channel, said web server software downloads to said second computer system said populated display/editor text, said screen layout text, and a portion of said web scripting software which translates said populated display/editor text into said second format and then populates said screen layout text with said translated text from said populated display/editor text.

28. The system as recited in claim 27, wherein said first format is XML and said second format is HTML.

29. A system comprising a scanner connected to a diagnostic service center via a communications channel, wherein said scanner is programmed to download the following to said diagnostic service center in response to a request: populated display/editor text in a first format, said populated display/editor text being populated with current scanner data, screen layout text in a second format different than said first format, and script for creating a display text in said second format based at least in part on said screen layout text and said populated display/editor text.

30. The system as recited in claim 29, wherein said first format is XML and said second format is HTML.
